(19) United States
(12) Patent Application Publication
(10) Pub. No.: US 2022/0163672 A1
(43) Pub. Date: May 26, 2022

(54) VEHICLE ATTITUDE OUTPUT DEVICE, POINT CLOUD 3D CONVERSION SYSTEM, VEHICLE ATTITUDE OUTPUT METHOD, POINT CLOUD 3D CONVERSION METHOD, VEHICLE ATTITUDE OUTPUT PROGRAM, AND POINT CLOUD 3D CONVERSION PROGRAM

(71) Applicant: NIPPON TELEGRAPH AND TELEPHONE CORPORATION, Tokyo (JP)

(72) Inventors: Shigehiro MATSUDA, Musashino-shi, Tokyo (JP); Yukihiro GOTO, Musashino-shi, Tokyo (JP); Ryuji HONDA, Musashino-shi, Tokyo (JP)

(73) Assignee: NIPPON TELEGRAPH AND TELEPHONE CORPORATION, Tokyo (JP)

(21) Appl. No.: 17/430,322

(22) PCT Filed: Jan. 31, 2020
(86) PCT No.: PCT/JP2020/003590

§ 371 Date: Aug. 11, 2021

(30) Foreign Application Priority Data
Feb. 14, 2019 (JP) 2019-024862

(51) Int. Cl. G01S 17/89; G06V 20/58; G06T 7/73; G06T 7/521

(52) U.S. Cl. CPC G01S 17/89; G06V 20/58; G06T 2207/30252; G06T 7/521; G06T 2207/10028; G06T 7/74

(57) ABSTRACT

An object of the present disclosure is, in performing three-dimensionalization of an object point cloud by a laser or a radar, to reduce an amount of calculation in the axial direction of three-dimensional space coordinates, into which the object point cloud is to be mapped, while increasing accuracy in the three-dimensionalization of the object point cloud. The present disclosure calculates an absolute value of a difference between vehicle attitude data with a high sampling frequency and vehicle attitude data with a low sampling frequency. When the absolute value of the difference is small, the vehicle attitude data with the high sampling frequency is decimated and the vehicle attitude data with the low sampling frequency is outputted, to thereby reduce the amount of calculation in the axial direction of the three-dimensional space coordinates, into which the object point cloud is to be mapped. On the other hand, when the absolute value of the difference is large, the vehicle attitude data with the high sampling frequency is outputted to increase the accuracy in the three-dimensionalization of the object point cloud. Finally, the object point cloud is three-dimensionalized based on the data of vehicle attitude and data of the object point cloud.

### TECHNICAL FIELD

The present disclosure relates to a technique that three-dimensionalizes an object point cloud by a laser or a radar.

### BACKGROUND ART

An MMS (Mobile Mapping System) is a vehicle loaded with a three-dimensional laser/radar scanner and an IMU (Inertial Measurement Unit) (for example, refer to Patent Literatures 1, 2, and the like). The three-dimensional laser/radar scanner obtains data of an object point cloud (laser/radar reflecting points on an object surface) while the vehicle is driving. The IMU obtains data of a vehicle attitude (a rolling angle, a yawing angle, and a pitching angle) while the vehicle is driving. The MMS maps the object point cloud into three-dimensional space coordinates based on the object point cloud data and the vehicle attitude data, to thereby three-dimensionalize the object point cloud.

### CITATION LIST

### Patent Literature

Patent Literature 1: Japanese Patent Laid-Open No. 2015-224980

Patent Literature 2: Japanese Patent Laid-Open No. 2015-232513

### SUMMARY OF THE INVENTION

### Technical Problem

In response to the accuracy of the vehicle attitude data, the accuracy in the axial direction of the three-dimensional space coordinates into which the object point cloud is to be mapped is determined, and thereby the accuracy in three-dimensionalization of the object point cloud is determined. To increase the accuracy in three-dimensionalization of the object point cloud, it can be considered that the sampling frequency of the vehicle attitude data is raised in view of variations in vehicle attitude caused by unevenness on a road. However, when the sampling frequency of the vehicle attitude data is raised, amount of information of the vehicle attitude data is increased; therefore, a problem is caused that an amount of calculation in the axial direction of the three-dimensional space coordinates into which the object point cloud is to be mapped is increased.

To solve the problem, an object of the present disclosure is, in performing three-dimensionalization of the object point cloud by a laser or a radar, to reduce the amount of calculation in the axial direction of the three-dimensional space coordinates, into which the object point cloud is to be mapped, while increasing the accuracy in the three-dimensionalization of the object point cloud.

### Means for Solving the Problem

To solve the above problem, an absolute value of the difference between the vehicle attitude data with the high sampling frequency and the vehicle attitude data with the low sampling frequency is calculated. When the absolute value of the difference is small, the vehicle attitude data with the high sampling frequency is decimated and the vehicle attitude data with the low sampling frequency is outputted, to thereby reduce the amount of calculation in the axial direction of the three-dimensional space coordinates into which the object point cloud is to be mapped. On the other hand, when the absolute value of the difference is large, the vehicle attitude data with the high sampling frequency is outputted to increase the accuracy in the three-dimensionalization of the object point cloud.

Specifically, the present disclosure provides a vehicle attitude output device including: a vehicle attitude output unit outputting data of vehicle attitude processed with a high sampling frequency and the data of the vehicle attitude processed with a low sampling frequency; a difference absolute value calculation unit calculating an absolute value of a difference between the data of the vehicle attitude processed with the high sampling frequency at a certain time and the data of the vehicle attitude processed with the low sampling frequency at a time nearest to the certain time; and a vehicle attitude decimation unit, (1) when the absolute value of the difference is not more than a difference threshold value, decimating the data of the vehicle attitude processed with the high sampling frequency at the certain time without adopting the data as data of the vehicle attitude at the certain time, and outputting the data of the vehicle attitude processed with the low sampling frequency at the time nearest to the certain time as the data of the vehicle attitude at the certain time, and, (2) when the absolute value of the difference is more than the difference threshold value, outputting the data of the vehicle attitude processed with the high sampling frequency at the certain time as the data of the vehicle attitude at the certain time.

Moreover, the present disclosure provides a vehicle attitude output method including the steps in the presented order: a vehicle attitude output step outputting data of vehicle attitude processed with a high sampling frequency and the data of the vehicle attitude processed with a low sampling frequency; a difference absolute value calculation step calculating an absolute value of a difference between the data of the vehicle attitude processed with the high sampling frequency at a certain time and the data of the vehicle attitude processed with the low sampling frequency at a time nearest to the certain time; and a vehicle attitude decimation step, (1) when the absolute value of the difference is not more than a difference threshold value, decimating the data of the vehicle attitude processed with the high sampling frequency at the certain time without adopting the data as data of the vehicle attitude at the certain time, and outputting the data of the vehicle attitude processed with the low sampling frequency at the time nearest to the certain time as the data of the vehicle attitude at the certain time, and, (2) when the absolute value of the difference is more than the difference threshold value, outputting the data of the vehicle attitude processed with the high sampling frequency at the certain time as the data of the vehicle attitude at the certain time.

Moreover, the present disclosure provides a vehicle attitude output program causing a computer to execute the steps in the presented order: a vehicle attitude output step outputting data of vehicle attitude processed with a high sampling frequency and the data of the vehicle attitude processed with a low sampling frequency; a difference absolute value calculation step calculating an absolute value of a difference between the data of the vehicle attitude processed with the high sampling frequency at a certain time and the data of the vehicle attitude processed with the low sampling frequency at a time nearest to the certain time; and a vehicle attitude decimation step, (1) when the absolute value of the difference is not more than a difference threshold value, decimating the data of the vehicle attitude processed with the high sampling frequency at the certain time without adopting the data as data of the vehicle attitude at the certain time, and outputting the data of the vehicle attitude processed with the low sampling frequency at the time nearest to the certain time as the data of the vehicle attitude at the certain time, and, (2) when the absolute value of the difference is more than the difference threshold value, outputting the data of the vehicle attitude processed with the high sampling frequency at the certain time as the data of the vehicle attitude at the certain time.

According to these configurations, preparation of processing to reduce the amount of calculation in the axial direction of the three-dimensional space coordinates, into which the object point cloud is to be mapped, while increasing the accuracy in the three-dimensionalization of the object point cloud becomes possible.

Moreover, the present disclosure provides the vehicle attitude output device in which the high sampling frequency is set higher than a frequency of variation in the vehicle attitude.

These configurations make it possible to increase the accuracy in the three-dimensionalization of the object point cloud when the variation frequency of the vehicle attitude is high, and make it possible to reduce the amount of calculation in the axial direction of the three-dimensional space coordinates, into which the object point cloud is to be mapped, when the variation frequency of the vehicle attitude is low.

Moreover, the present disclosure provides a point cloud three-dimensionalization system including: the above-described vehicle attitude output device; and a point cloud three-dimensionalization device three-dimensionalizing an object point cloud at the certain time based on the data of the vehicle attitude at the certain time and data of the object point cloud at the certain time.

Moreover, the present disclosure provides a point cloud three-dimensionalization method including the steps in the presented order: the respective steps of the above-described vehicle attitude output method; and a point cloud three-dimensionalization step three-dimensionalizing an object point cloud at the certain time based on the data of the vehicle attitude at the certain time and data of the object point cloud at the certain time.

Moreover, the present disclosure provides a point cloud three-dimensionalization program causing a computer to execute the steps in the presented order: the respective steps of the above-described vehicle attitude output program; and a point cloud three-dimensionalization step three-dimensionalizing an object point cloud at the certain time based on the data of vehicle attitude at the certain time and data of the object point cloud at the certain time.

According to these configurations, actual processing to reduce the amount of calculation in the axial direction of the three-dimensional space coordinates, into which the object point cloud is to be mapped, while increasing the accuracy in the three-dimensionalization of the object point cloud becomes possible.

Moreover, the present disclosure provides the point cloud three-dimensionalization system in which the difference threshold value is set in accordance with desired accuracy in three-dimensionalization of the object point cloud.

According to the configuration, it is possible to increase the accuracy in the three-dimensionalization of the object point cloud when desired accuracy in the three-dimensionalization of the object point cloud is high, and makes it possible to reduce the amount of calculation in the axial direction of the three-dimensional space coordinates, into which the object point cloud is to be mapped, when the desired accuracy in the three-dimensionalization of the object point cloud is low.

### Effects of the Invention

As described above, in performing three-dimensionalization of the object point cloud by a laser or a radar, the present disclosure makes it possible to reduce the amount of calculation in the axial direction of the three-dimensional space coordinates, into which the object point cloud is to be mapped, while increasing the accuracy in the three-dimensionalization of the object point cloud.

### BRIEF DESCRIPTION OF DRAWINGS

FIG. 1 is a diagram showing a configuration of a point cloud three-dimensionalization system according to the present disclosure.

FIG. 2 is a diagram showing processing of the point cloud three-dimensionalization system according to the present disclosure.

FIG. 3 is a diagram showing a method of decimating vehicle attitude data according to the present disclosure.

FIG. 4 is a diagram showing a method of setting a sampling frequency according to the present disclosure.

FIG. 5 is a diagram showing a method of setting a difference threshold value according to the present disclosure.

### DESCRIPTION OF EMBODIMENTS

An exemplary embodiment according to the present disclosure will be described with reference to attached drawings. The exemplary embodiment to be described as follows is an example of practicing the present disclosure, and the present disclosure is not limited to the following exemplary embodiment.

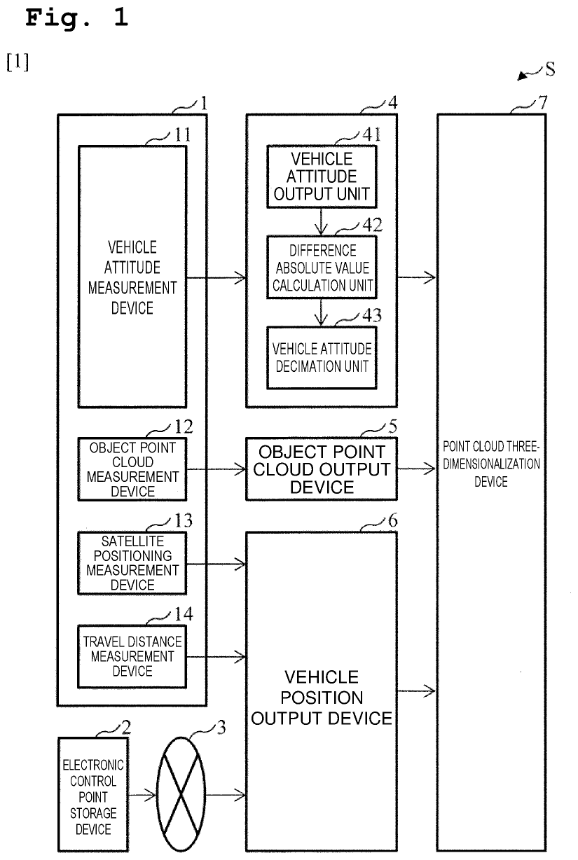

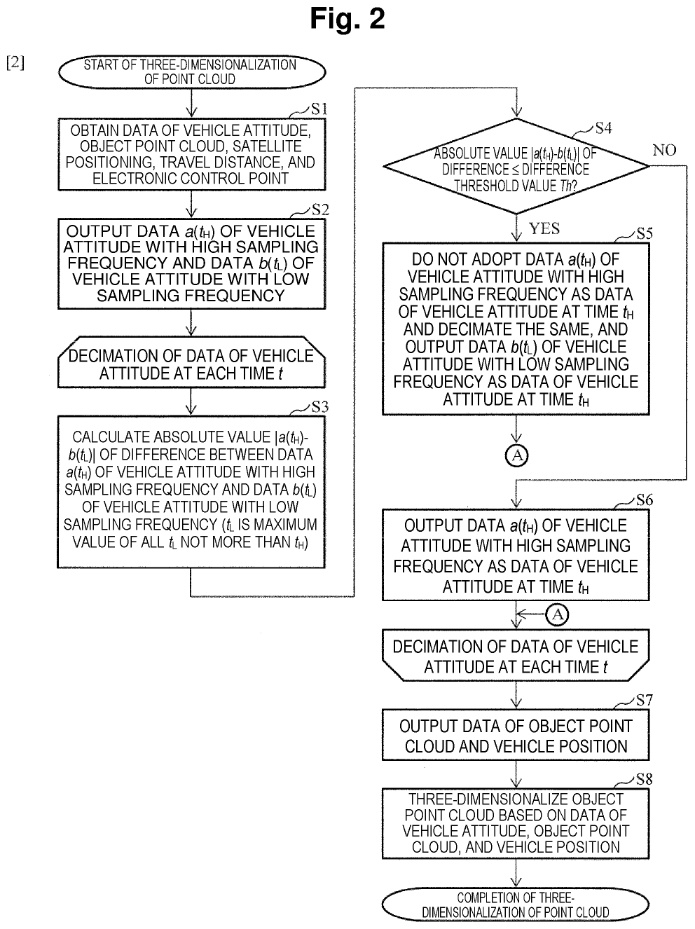

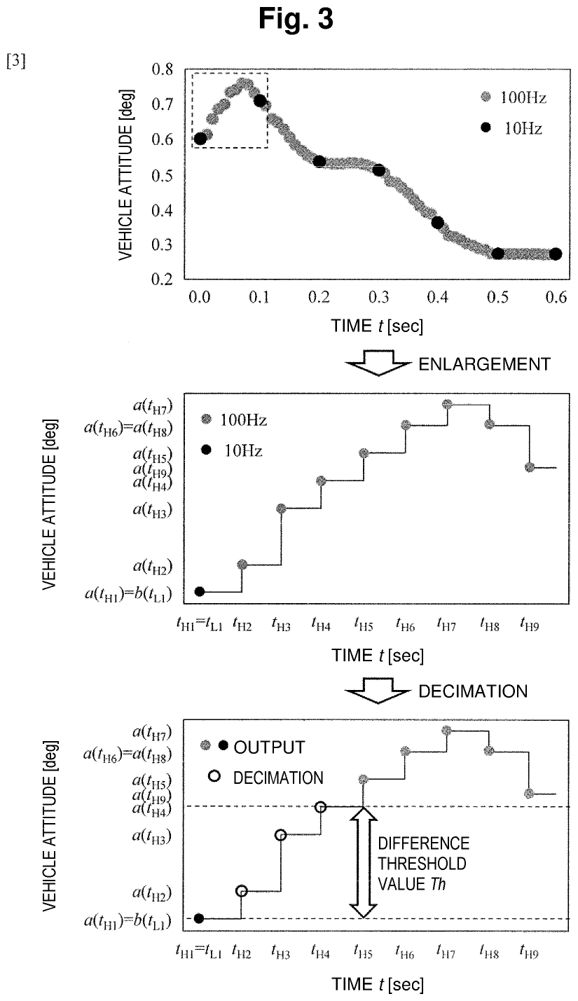

A configuration of a point cloud three-dimensionalization system according to the present disclosure is shown in FIG. 1. Processing of the point cloud three-dimensionalization system according to the present disclosure is shown in FIG. 2. A method of decimating vehicle attitude data according to the present disclosure is shown in FIG. 3.

The point cloud three-dimensionalization system S is configured with: a vehicle-mounted measurement device 1; an electronic control point storage device 2; a network 3; a vehicle attitude output device 4; an object point cloud output device 5; a vehicle position output device 6; and a point cloud three-dimensionalization device 7. The vehicle-mounted measurement device 1 is configured with: a vehicle attitude measurement device 11; an object point cloud measurement device 12; a satellite positioning measurement device 13; and a travel distance measurement device 14. The vehicle attitude output device 4 is configured with: a vehicle attitude output unit 41; a difference absolute value calculation unit 42; and a vehicle attitude decimation unit 43. The vehicle attitude output device 4, the object point cloud output device 5, the vehicle position output device 6 and the point cloud three-dimensionalization device 7 can be implemented by installing a vehicle attitude output program as shown in FIG. 3 and a point cloud three-dimensionalization program on a computer.

The vehicle-mounted measurement device 1 constitutes the MMS (Mobile Mapping System) and mounted on a vehicle. The vehicle attitude measurement device 11 is the IMU (Inertial Measurement Unit) or the like, and obtains data of a vehicle attitude (a rolling angle, a yawing angle, and a pitching angle) while the vehicle is driving. The object point cloud measurement device 12 is the three-dimensional laser/radar scanner or the like and obtains data of an object point cloud (laser/radar reflecting points on an object surface) while the vehicle is driving. The satellite positioning measurement device 13 is a GPS (Global Positioning System) or the like, and obtains data of satellite positioning while the vehicle is driving. The travel distance measurement device 14 is an odometer or the like, and obtains data of travel distance while the vehicle is driving. The electronic control point storage device 2 provides data of electronic control points (a kind of control points and observation points in surveying) to the vehicle position output device 6 via the network 3.

The vehicle attitude output device 4 obtains the data of vehicle attitude (step S1). The object point cloud output device 5 obtains the data of object point cloud (step S1). The vehicle position output device 6 obtains the data of satellite positioning, travel distance and electronic control points (step S1).

The vehicle attitude output unit 41 outputs data a(t_{H}) of the vehicle attitude with a high sampling frequency and data b(t_{L}) of the vehicle attitude with a low sampling frequency (step S2).

The upper stage in FIG. 3 shows the data a(t_{H}) of the vehicle attitude with a high sampling frequency (100 Hz) and the data b(t_{L}) of the vehicle attitude with a low sampling frequency (10 Hz) over the range of time t from 0.0 [sec] to 0.6 [sec]. The middle stage in FIG. 3 shows the data a(t_{H}) of the vehicle attitude with a high sampling frequency (100 Hz) and the data b(t_{L}) of the vehicle attitude with a low sampling frequency (10 Hz) over the range of time t from 0.0 [sec] to 0.1 [sec] that have been enlarged.

The times till, t_{H2}, t_{H3}, t_{H4}, t_{H5}, t_{H6}, t_{H7}, t_{H8}, and t_{H9} are sampling times for the high sampling frequency (100 Hz), and the time t_{L1} is a sampling time for the low sampling frequency (10 Hz), where the expression t_{H1}=t_{L1}<t_{H2}<t_{H3}<t_{H4}<t_{H5}<t_{H6}<t_{H7}<t_{H8}<t_{H9} holds. The vehicle attitudes a(t_{H1}), a(t_{H2}), a(t_{H3}), a(t_{H4}), a(t_{H5}), a(t_{H6}), a(t_{H7}), a(t_{H8}), and a(t_{H9}) are vehicle attitudes with the high sampling frequency (100 Hz), and the vehicle attitude b(t_{L1}) is a vehicle attitude with the low sampling frequency (10 Hz), where the expression a(t_{H1})=b(t_{L1})<a(t_{H2})<a(t_{H3})<a(t_{H4})<a(t_{H9})<a(t_{H5})<a(t_{H6})=a(t_{H8})<a(t_{H7}) holds.

The data of vehicle attitude is decimated at each time t as shown in steps S3 to S6.

The difference absolute value calculation unit 42 calculates an absolute value |a(t_{H})−b(t_{L})| of the difference between the data a(t_{H}) of the vehicle attitude with the high sampling frequency and the data b(t_{L}) of the vehicle attitude with the low sampling frequency (step S3). Here, the time t_{L} is the nearest time to the time t_{H} from among all the times t_{L}, and the maximum value of all the times t_{L} not more than the time t_{H.}

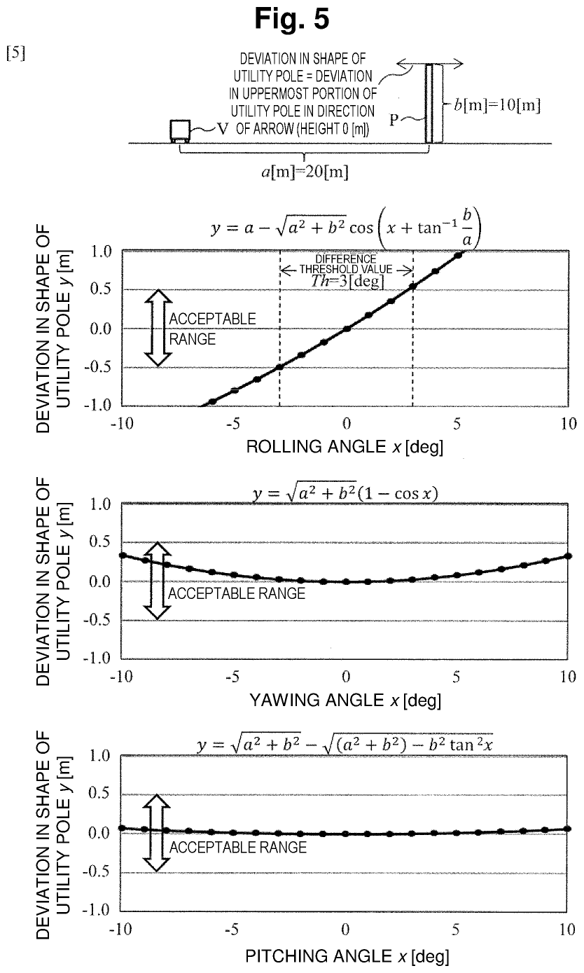

When the absolute value |a(t_{H})−b(t_{L})| of the difference is not more than a difference threshold value Th (YES in step S4), the vehicle attitude decimation unit 43 decimates the data a(t_{H}) of the vehicle attitude with the high sampling frequency without adopting the data a(t_{H}) as the data of the vehicle attitude at the time t_{H}, and outputs the data b(t_{L}) of the vehicle attitude with the low sampling frequency as the data of the vehicle attitude at the time t_{H} (step S5). Here, the difference threshold value Th is set as shown in FIG. 5.

On the other hand, when the absolute value |a(t_{H})−b(t_{L})| of the difference is more than the difference threshold value Th (NO in step S4), the vehicle attitude decimation unit 43 outputs the data a(t_{H}) of the vehicle attitude with the high sampling frequency as the data of the vehicle attitude at the time t_{H} (step S6).

The lower stage in FIG. 3 shows the data a(t_{H}) of the vehicle attitude with a high sampling frequency (100 Hz) and the data b(t_{L}) of the vehicle attitude with a low sampling frequency (10 Hz) over the range of time t from 0.0 [sec] to 0.1 [sec] that have been subjected to decimation. Here, the decimated data is indicated by a white circle.

As for the vehicle attitudes a(t_{H1}), a(t_{H2}), a(t_{H3}), and a(t_{H4}), since the absolute value |a(t_{H})−b(t_{L1})| of the difference is not more than the difference threshold value Th (YES in step S4), the vehicle attitudes a(t_{H1}), a(t_{H2}), a(t_{H3}), and a(t_{H4}) are not adopted as the data of the vehicle attitudes at the times t_{H1}, t_{H2}, t_{H3}, and t_{H4}, respectively, and decimated, whereas, the vehicle attitude b(t_{L1}) is outputted as the data of the vehicle attitudes at the times t_{H1}, t_{H2}, t_{H3}, and t_{H4} (step S5). Consequently, the amount of calculation in the axial direction of the three-dimensional space coordinates, into which the object point cloud is to be mapped, is reduced.

As for the vehicle attitudes a(t_{H5}), a(t_{H6}), a(t_{H7}), a(t_{H8}), and a(t_{H9}), since the absolute value |a(t_{H})−b(t_{L1})| of the difference is more than the difference threshold value Th (NO in step S4), the vehicle attitudes a(t_{H5}), a(t_{H6}), a(t_{H7}), a(t_{H8}), and a(t_{H9}) are outputted as the data of the vehicle attitudes at the times t_{H5}, t_{H6}, t_{H7}, t_{H8}, and t_{H9}, respectively (step S6). Consequently, the accuracy in the three-dimensionalization of the object point cloud is increased.

The object point cloud output device 5 outputs the data of the object point cloud at each time t (step S7). The vehicle position output device 6 outputs the data of vehicle position at each time t (step S7).

Based on the vehicle attitude data at each time t, the object point cloud data at each time t, and the vehicle position data at each time t, the point cloud three-dimensionalization device 7 maps the object point cloud at each time t into the three-dimensional space coordinates, to thereby three-dimensionalize the object point cloud at each time t (step S8).

As described above, the point cloud three-dimensionalization system S makes it possible to reduce the amount of calculation in the axial direction of the three-dimensional space coordinates, into which the object point cloud is to be mapped, while increasing the accuracy in the three-dimensionalization of the object point cloud.

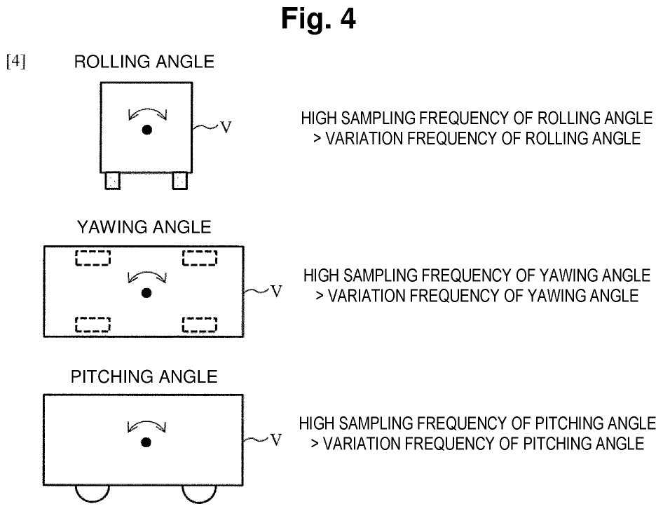

FIG. 4 shows a method of setting the sampling frequency in the present disclosure. The high sampling frequency of the attitude of the vehicle V is set higher than a variation frequency of the attitude of the vehicle V. For example, the high sampling frequency of the rolling angle is set higher than a predetermined or actually-measured variation frequency of the rolling angle. The high sampling frequency of the yawing angle is set higher than a predetermined or actually-measured variation frequency of the yawing angle. Further, the high sampling frequency of the pitching angle is set higher than a predetermined or actually-measured variation frequency of the pitching angle.

Note that there is no problem in setting the low sampling frequency of the attitude of the vehicle V at the same degree as the variation frequency of the attitude of the vehicle V. For example, there is no problem in setting the low sampling frequency of the rolling angle at the same degree as the predetermined or actually-measured variation frequency of the rolling angle. Then, there is no problem in setting the low sampling frequency of the yawing angle at the same degree as the predetermined or actually-measured variation frequency of the yawing angle. Further, there is no problem in setting the low sampling frequency of the pitching angle at the same degree as the predetermined or actually-measured variation frequency of the pitching angle.

As described above, the present disclosure makes it possible to increase the accuracy in the three-dimensionalization of the object point cloud when the variation frequency of the attitude of the vehicle V is high, and makes it possible to reduce the amount of calculation in the axial direction of the three-dimensional space coordinates, into which the object point cloud is to be mapped, when the variation frequency of the attitude of the vehicle V is low.

FIG. 5 shows a method of setting the difference threshold value in the present disclosure. The difference threshold value Th is set in accordance with desired accuracy in the three-dimensionalization of the object point cloud. For example, suppose the height of the MMS in the vehicle V is 0 [m], a distance between the vehicle V and a utility pole P is a [m]=20 [m], a straight line connecting the vehicle V and the utility pole P is parallel to a pitching axis of the vehicle V, and the height of the utility pole P is b [m]=10 [m]. Then, suppose a deviation y [m] in the shape of the utility pole P on the assumption that the vehicle attitude is 0 [deg], which is a fixed value, despite the fact that the vehicle attitude is actually x [deg], is defined as the deviation in the uppermost portion of the utility pole P, the deviation being in a direction parallel to the pitching axis of the vehicle V.

The relation between the rolling angle x [deg] and the deviation y [m] in the shape of the utility pole P is given by Expression 1. When the acceptable range of the deviation y [m] in the shape of the utility pole P is −0.5≤y≤0.5, the difference threshold value Th of the rolling angle x [deg] may be set to 3 [deg].

$$\begin{matrix}[ Math . 1 ] & \\ y = a - \sqrt{{a}^{2} + {b}^{2}} cos ( x + {tan}^{- 1} \frac{b}{a} ) & Expression 1\end{matrix}$$

The relation between the yawing angle x [deg] and the deviation y [m] in the shape of the utility pole P is given by Expression 2. When the acceptable range of the deviation y [m] in the shape of the utility pole P is −0.5≤y≤0.5, the difference threshold value Th of the yawing angle x [deg] may be set to 10 [deg] or more.

[Math. 2]

y=\sqrt{a²+b²}(1−cos x) Expression 2

The relation between the pitching angle x [deg] and the deviation y [m] in the shape of the utility pole P is given by Expression 3. When the acceptable range of the deviation y [m] in the shape of the utility pole P is −0.5≤y≤0.5, the difference threshold value Th of the pitching angle x [deg] may be set to 10 [deg] or more.

[Math. 3]

y=\sqrt{a²b²}−\sqrt{(a²+b²)−b² tan² x} Expression 3

As described above, the present disclosure makes it possible to increase the accuracy in the three-dimensionalization of the object point cloud when desired accuracy in the three-dimensionalization of the object point cloud is high, and makes it possible to reduce the amount of calculation in the axial direction of the three-dimensional space coordinates, into which the object point cloud is to be mapped, when the desired accuracy in the three-dimensionalization of the object point cloud is low.

### INDUSTRIAL APPLICABILITY

In performing three-dimensionalization of the object point cloud by a laser or a radar, the vehicle attitude output device, the point cloud three-dimensionalization system, the vehicle attitude output method, the point cloud three-dimensionalization method, the vehicle attitude output program, and the point cloud three-dimensionalization program according to the present disclosure make it possible to reduce the amount of calculation in the axial direction of the three-dimensional space coordinates, into which the object point cloud is to be mapped, while increasing the accuracy in the three-dimensionalization of the object point cloud.

### REFERENCE SIGNS LIST

S Point cloud three-dimensionalization system

V Vehicle

P Utility pole

1 Vehicle-mounted measurement device

2 Electronic control point storage device

3 Network

4 Vehicle attitude output device

5 Object point cloud output device

6 Vehicle position output device

7 Point cloud three-dimensionalization device

11 Vehicle attitude measurement device

12 Object point cloud measurement device

13 Satellite positioning measurement device

14 Travel distance measurement device

41 Vehicle attitude output unit

42 Difference absolute value calculation unit

43 Vehicle attitude decimation unit

1. A vehicle attitude output device comprising:
a processor; and
a storage medium having computer program instructions stored thereon, when executed by the processor, perform to:
outputting data of vehicle attitude processed with a high sampling frequency and the data of the vehicle attitude processed with a low sampling frequency;
calculating an absolute value of a difference between the data of the vehicle attitude processed with the high sampling frequency at a certain time and the data of the vehicle attitude processed with the low sampling frequency at a time nearest to the certain time; and
(1) when the absolute value of the difference is not more than a difference threshold value, decimating the data of the vehicle attitude processed with the high sampling frequency at the certain time without adopting the data as data of the vehicle attitude at the certain time, and outputting the data of the vehicle attitude processed with the low sampling frequency at the time nearest to the certain time as the data of the vehicle attitude at the certain time, and, (2) when the absolute value of the difference is more than the difference threshold value, outputting the data of the vehicle attitude processed with the high sampling frequency at the certain time as the data of the vehicle attitude at the certain time.

2. The vehicle attitude output device according to claim 1, wherein the high sampling frequency is set higher than a frequency of variation in the vehicle attitude.

3. A point cloud three-dimensionalization system comprising:
the vehicle attitude output device according to claim 1; and
a point cloud three-dimensionalization device three-dimensionalizing an object point cloud at the certain time based on the data of the vehicle attitude at the certain time and data of the object point cloud at the certain time.

4. The point cloud three-dimensionalization system according to claim 3, wherein the difference threshold value is set in accordance with desired accuracy in three-dimensionalization of the object point cloud.

5. A vehicle attitude output method comprising the steps in the presented order:
a vehicle attitude output step outputting data of vehicle attitude processed with a high sampling frequency and the data of the vehicle attitude processed with a low sampling frequency;
a difference absolute value calculation step calculating an absolute value of a difference between the data of the vehicle attitude processed with the high sampling frequency at a certain time and the data of the vehicle attitude processed with the low sampling frequency at a time nearest to the certain time; and
a vehicle attitude decimation step, (1) when the absolute value of the difference is not more than a difference threshold value, decimating the data of the vehicle attitude processed with the high sampling frequency at the certain time without adopting the data as data of the vehicle attitude at the certain time, and outputting the data of the vehicle attitude processed with the low sampling frequency at the time nearest to the certain time as the data of the vehicle attitude at the certain time, and, (2) when the absolute value of the difference is more than the difference threshold value, outputting the data of the vehicle attitude processed with the high sampling frequency at the certain time as the data of the vehicle attitude at the certain time.

6. A point cloud three-dimensionalization method comprising the steps in the presented order:
the respective steps of the vehicle attitude output method according to claim 5; and
a point cloud three-dimensionalization step three-dimensionalizing an object point cloud at the certain time based on the data of the vehicle attitude at the certain time and data of the object point cloud at the certain time.

7. A vehicle attitude output program causing a computer to execute the steps in the presented order:
a vehicle attitude output step outputting data of vehicle attitude processed with a high sampling frequency and the data of the vehicle attitude processed with a low sampling frequency;
a difference absolute value calculation step calculating an absolute value of a difference between the data of the vehicle attitude processed with the high sampling frequency at a certain time and the data of the vehicle attitude processed with the low sampling frequency at a time nearest to the certain time; and
a vehicle attitude decimation step, (1) when the absolute value of the difference is not more than a difference threshold value, decimating the data of the vehicle attitude processed with the high sampling frequency at the certain time without adopting the data as data of the vehicle attitude at the certain time, and outputting the data of the vehicle attitude processed with the low sampling frequency at the time nearest to the certain time as the data of the vehicle attitude at the certain time, and, (2) when the absolute value of the difference is more than the difference threshold value, outputting the data of the vehicle attitude processed with the high sampling frequency at the certain time as the data of the vehicle attitude at the certain time.

8. A point cloud three-dimensionalizing program causing a computer to execute the steps in the presented order:
the respective steps of the vehicle attitude output program according to claim 7; and
a point cloud three-dimensionalization step three-dimensionalizing an object point cloud at the certain time based on the data of vehicle attitude at the certain time and data of the object point cloud at the certain time.
